(19) United States
(12) Patent Application Publication
(10) Pub. No.: US 2021/0335060 A1
(43) Pub. Date: Oct. 28, 2021

(54) SYSTEM AND METHOD FOR PROCESSING A RELIABILITY REPORT ASSOCIATED WITH A VEHICLE

(71) Applicant: Honda Motor Co., Ltd., Tokyo (JP)

(72) Inventors: Eric C. Bauer, Raymond, OH (US); Areeb Ahmed, Perrysburg, OH (US); Tyler Liam Baratz, Hollywood, FL (US); Joan R. Smith, Plain City, OH (US)

(21) Appl. No.: 17/239,388

(22) Filed: Apr. 23, 2021

Related U.S. Application Data
(60) Provisional application No. 63/015,098, filed on Apr. 24, 2020.

(51) Int. Cl. G07C 5/00; G07C 5/08; G06Q 10/00

(52) U.S. Cl. CPC G07C 5/008; G06Q 10/20; G07C 5/0816

(57) ABSTRACT

A system and method for processing a reliability report associated with a vehicle that include receiving vehicle utilization data associated with dynamic operation, safe operation, and maintenance of the vehicle and assigning reliability scores to utilization categories of the vehicle based on the vehicle utilization data. The system and method also include processing reliability rankings that are associated with each of the utilization categories based on a comparison of the reliability scores to reliability scores that are associated with utilization categories of a plurality of vehicles that are available for resale. The system and method further include processing the reliability report of the vehicle that includes reliability rankings that are associated with each of the utilization categories.

### CROSS-REFERENCE TO RELATED APPLICATION

This application claims priority to U.S. Provisional Application Ser. No. 63/015,098 filed on Apr. 24, 2020, which is expressly incorporated herein by reference.

### BACKGROUND

Currently, it is challenging for consumers who are shopping for pre-owned/leased vehicles to truly understand or predict a reliability of a vehicle that may be available for purchase. In many cases, consumers may only determine basic information regarding a year, make, model, and determine certain physical characteristics of vehicles to determine if they are potentially purchasing a quality reliable product. Additionally, certain basic information may be available to consumers regarding a current state of the vehicle, accident tracking of the vehicle, and/or body work associated with the vehicle. However, such details may not provide a full picture that may allow the consumers to truly determine if a particular vehicle may be distinguishable from other vehicles that are available in the vehicle resale marketplace being more reliable based on how the vehicle was utilized by a previous owner and/or lessee of the vehicle.

In many cases, when vehicles are being leased out by a vehicle manufacturer prior to being put on the pre-owned vehicle market, there is little to no incentive for a driver of a leased vehicle to operate and/or maintain the leased vehicle in a manner as if the vehicle is owned by the driver. Accordingly, in many instances leased vehicles are not operated and/or maintained in a similar manner as vehicles that are owned by drivers. In many instances leased vehicles may be returned to a dealership after being operated in a rough manner with a high amount of wear and tear, damage, and/or with malfunctioning components which may thereby affect their reliability with respect to a future owner of the pre-leased vehicle.

### BRIEF DESCRIPTION

According to one aspect, a computer-implemented method for processing a reliability report associated with a vehicle that includes receiving vehicle utilization data associated with dynamic operation, safe operation, and maintenance of the vehicle. The computer-implemented method also includes assigning reliability scores to utilization categories of the vehicle based on the vehicle utilization data. The utilization categories include a driving performance category, a mileage category, a wear and tear category, and a maintenance and repair category. The computer implemented method further includes processing reliability rankings that are associated with each of the utilization categories based on a comparison of the reliability scores to reliability scores that are associated with utilization categories of a plurality of vehicles that are available for resale and processing the reliability report of the vehicle that includes reliability rankings that are associated with each of the utilization categories.

According to another aspect, a system for processing a reliability report associated with a vehicle that includes a memory storing instructions when executed by a processor cause the processor to receive vehicle utilization data associated with dynamic operation, safe operation, and maintenance of the vehicle. The instructions also cause the processor to assign reliability scores to utilization categories of the vehicle based on the vehicle utilization data. The utilization categories include a driving performance category, a mileage category, a wear and tear category, and a maintenance and repair category. The instructions further cause the processor to process reliability rankings that are associated with each of the utilization categories based on a comparison of the reliability scores to reliability scores that are associated with utilization categories of a plurality of vehicles that are available for resale and process the reliability report of the vehicle that includes reliability rankings that are associated with each of the utilization categories.

According to yet another aspect, a non-transitory computer readable storage medium storing instructions that when executed by a computer, which includes a processor perform a method that includes receiving vehicle utilization data associated with dynamic operation, safe operation, and maintenance of a vehicle. The method also includes assigning reliability scores to utilization categories of the vehicle based on the vehicle utilization data. The utilization categories include a driving performance category, a mileage category, a wear and tear category, and a maintenance and repair category. The method further includes processing reliability rankings that are associated with each of the utilization categories based on a comparison of the reliability scores to reliability scores that are associated with utilization categories of a plurality of vehicles that are available for resale and processing a reliability report of the vehicle that includes reliability rankings that are associated with each of the utilization categories.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for processing a reliability report associated with a pre-owned/leased vehicle (vehicle) according to an exemplary embodiment of the present disclosure

FIG. 2A is an illustrative example of a reliability report processed by a vehicle reliability application according to an exemplary embodiment of the present disclosure;

FIG. 2B is an illustrative example of a mileage utilization category information interface of the reliability report according to an exemplary embodiment of the present disclosure;

FIG. 2C is an illustrative example of a wear and tear utilization category information interface of the reliability report according to an exemplary embodiment of the present disclosure;

FIG. 2D is an illustrative example of a maintenance and repair utilization category information interface of the reliability report according to an exemplary embodiment of the present disclosure;

FIG. 2E is an illustrative example of a driving performance utilization category information interface of the reliability report according to an exemplary embodiment of the present disclosure;

FIG. 3 is an illustrative example of a vehicle reliability user interface of the vehicle reliability application according to an exemplary embodiment of the present disclosure;

FIG. 4 is a schematic view of a plurality of modules of the vehicle reliability application for processing the reliability report associated with the vehicle according to an exemplary embodiment of the present disclosure;

FIG. 5 is a process flow diagram of a method for populating data logs with vehicle utilization data during an ownership period or a lease term of the vehicle according to an exemplary embodiment of the present disclosure;

FIG. 6 is a process flow diagram of a method for assigning reliability scores and determining reliability rankings that are associated with the utilization categories of the vehicle and processing the reliability report associated with the vehicle according to an exemplary embodiment of the present disclosure; and

FIG. 7 is a process flow diagram of a method for processing a reliability report associated with a vehicle according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area network (CAN), Media Oriented System Transport (MOST), Local Interconnect Network (LIN), among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device,” as used herein may include devices for controlling different vehicle features which include various vehicle components, systems, and subsystems. The term “input device” includes, but it not limited to: push buttons, rotary knobs, and the like. The term “input device” additionally includes graphical input controls that take place within a user interface which may be displayed by various types of mechanisms such as software and hardware based controls, interfaces, or plug and play devices.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software controlled microprocessor, a discrete logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

An “output device,” as used herein may include devices that may derive from vehicle components, systems, subsystems, and electronic devices. The term “output devices” includes, but is not limited to: display devices, and other devices for outputting information and functions.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “vehicle,” as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, personal watercraft, and aircraft. In some cases, a motor vehicle includes one or more engines.

A “vehicle system,” as used herein may include, but are not limited to, any automatic or manual systems that may be used to enhance the vehicle, driving and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, among others.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

### I. System Overview

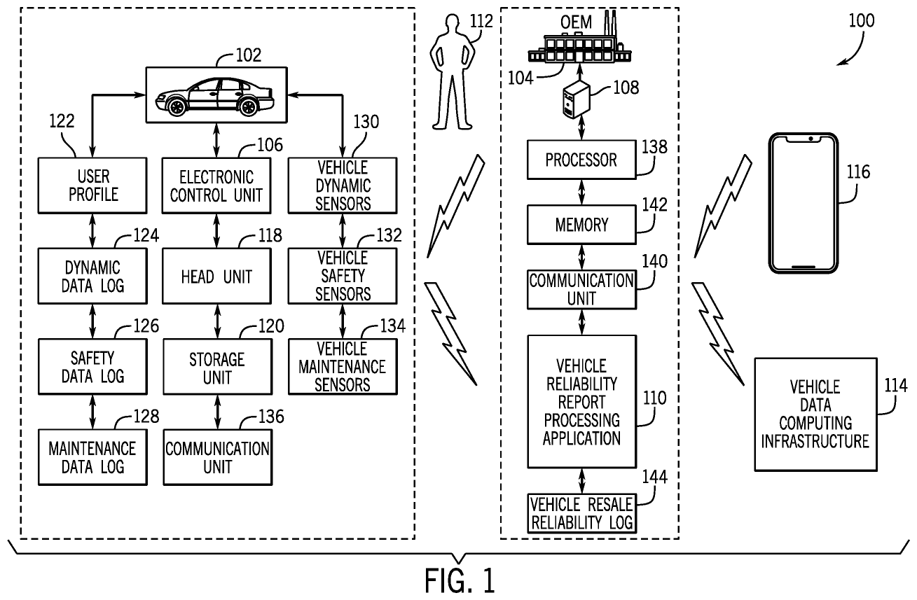

Referring now to the drawings, wherein the showings are for purposes of illustrating one or more exemplary embodiments and not for purposes of limiting the same, FIG. 1 is a schematic view of an exemplary operating environment 100 for processing a reliability report associated with a pre-owned/leased vehicle (vehicle) 102 according to an exemplary embodiment of the present disclosure. The vehicle 102 may be owned by an individual (individual owner, corporation) who previously purchased the vehicle 102 from a vehicle dealership (not shown) or third-party entity (not shown) for a period of time. Alternatively, the vehicle 102 may be leased for a predetermined period of time that may be associated with a particular lease term (e.g., 1 month, 12 months, 24 months, 36 months, etc.) through a vehicle manufacturer (OEM) 104, a vehicle dealership, and/or a third-party entity.

The vehicle 102 may include a plurality of components that may be operably controlled by an electronic control unit (ECU) 106 of the vehicle 102. The vehicle 102 may be configured to communicate with an externally hosted computing infrastructure (external server) 108 that may be managed by the OEM 104, one or more vehicle dealerships, and/or or a third-party entity. As discussed below, the ECU 106 and/or the external server 108 may be configured to execute a vehicle reliability report processing application (vehicle reliability application) 110 that may be executed to process a reliability report that is associated with the utilization of the vehicle 102 during an ownership period (e.g., a duration of the ownership) of the vehicle 102 and/or a lease term (e.g., from a start of a lease to an end of a lease) of the vehicle 102. It is to be appreciated that the embodiments disclosed herein will further discuss the sale of the vehicle 102 as a pre-owned/leased vehicle to be provided through the OEM 104 and/or one or more vehicle dealerships. However, it is to be appreciated that the sale of the vehicle 102 may also be provided through one or more third party entities (e.g., corporations, public entities, rental car companies) and/or individuals.

As discussed below, the vehicle reliability application 110 may be configured to determine various reliability rankings associated with the utilization of the vehicle 102. In particular, the reliability rankings may be associated with various utilization categories that are associated with specific aspects of utilization of the vehicle 102. The utilization categories may include a driving performance category which is associated with how the vehicle 102 has been driven by one or more drivers (not shown) during the ownership period or lease term of the vehicle 102. For example, the driving performance category may include a breakdown of acceleration, braking, steering, handling, etc. of the vehicle 102.

The utilization categories may also include a mileage category that pertains to the overall mileage of the vehicle 102 and/or a breakdown of a type of operation of the vehicle 102 that may be associated with the mileage of the vehicle 102. For example, the breakdown may include highway cruising mileage vs. city stop and go mileage, towing load mileage breakdowns, vehicle disablement breakdown, movement/braking mileage breakdown, and the like. The utilization categories may also include a wear and tear category of the vehicle 102 that may pertain to the overall wear and tear of certain electrical and mechanical components of the vehicle 102 (e.g., wear and tear of shocks and struts based on driving in potholes). The wear and tear category may include a breakdown of wear and tear of particular components of the vehicle 102 that may be caused by time, vehicle handling, road conditions, and/or environmental conditions.

Furthermore, the utilization categories may include a maintenance and repair category of the vehicle 102 that pertains to how the vehicle 102 has been maintained and how electronic, mechanical, and/or vehicle body related issues have been repaired. The maintenance and repair category of the vehicle 102 may include a breakdown of preventive maintenance (e.g., tire rotations), regular component maintenance (e.g., oil changes, tire changes, brake pad replacement), warranty claims, and repairs (e.g., component repairs, vehicle structural repairs).

In an exemplary embodiment, the vehicle reliability application 110 may be configured to execute logic that may enable the application 110 to analyze vehicle utilization data that may be based on sensor data received by one or more sensors (discussed in more detail below) of the vehicle 102 and/or through a vehicle data computing infrastructure 114 (discussed in more detail below) upon the ownership and/or the lease of the vehicle 102 by the individual 112. The vehicle reliability application 110 may be configured to analyze various types of vehicle utilization data to assign respective reliability scores (e.g., a value between 1-10) that may be associated with the respective utilization categories. Stated differently, the reliability scores may be assigned to respective utilization classifications that pertain to how the vehicle 102 has been driven, operated, utilized, and/or maintained by the individual 112 during the ownership period or the lease term of the vehicle 102.

In an exemplary embodiment, the utilization categories associated with the vehicle 102 may be rated and categorized based on the respectively assigned reliability scores to indicate how the vehicle 102 has been driven, used, operated, and/or maintained by the individual 112 during the ownership period or the lease term of the vehicle 102 prior to the vehicle 102 being made available within the vehicle resale marketplace (upon completion of the ownership period or lease term). As discussed below, the reliability scores that are assigned to each of the utilization categories may be analyzed in comparison to additional vehicles (not shown) that may be available within the vehicle resale marketplace. The reliability rankings and associated vehicle related information may be populated within the processed reliability report that is associated with the vehicle 102 to allow consumers in the pre-owned vehicle resale marketplace, vehicle dealers, the OEM 104, and/or third-party entities to determine the reliability of the vehicle 102 in comparison to additional vehicles (one or more subsets of vehicles) that may be available for resale in the vehicle resale marketplace.

In one or more embodiments, the vehicle reliability application 110 may be configured to promote a higher quality utilization of the vehicle 102 by the individual who owns or who is leasing the vehicle 102 prior to the vehicle 102 being made available within the resale market. The higher quality utilization of the vehicle 102 may allow the vehicle 102 to be ranked higher in one or more utilization categories. In circumstances in which the vehicle 102 is ranked high in one or more utilization categories, the reliability report may be used to distinguish the vehicle 102 as a unique high quality product in the highly competitive vehicle resale marketplace. Accordingly, the reliability report may be used to promote the vehicle 102 as a highly reliable product which may result in the vehicle 102 being resold at an increased price point. As such, the reliability report may function to provide market and consumer confidence that may accelerate the demand for the vehicle 102 in the vehicle resale marketplace.

In one embodiment, based on the utilization of the vehicle 102 by the individual, the vehicle reliability application 110 may be configured to determine one or more monetary values that may be associated with the vehicle 102. The one or more monetary values may include, but may not be limited to, a residual value of the vehicle 102 (in the event that the vehicle 102 has been leased by the individual 112), an estimated resale value of the vehicle 102, an estimated cost to the OEM 104 to certify the vehicle 102 as a certified pre-owned vehicle that is included with certified pre-owned vehicle OEM warranty, and/or a discount that may be calculated and associated with the individual 112 towards the lease or purchase of another vehicle from the OEM 104. Upon determining the one or more monetary values, the vehicle reliability application 110 may be configured to communicate the one or more monetary values to the OEM 104, one or more vehicle dealerships, and/or or a third-party entities to allow the OEM 104, one or more vehicle dealerships, and/or or a third-party entities to analyze the values and incorporate them into respective pricing structures.

In one embodiment, the various types of vehicle utilization data that may be used to assign reliability scores to one or more utilization categories may pertain to vehicle dynamic data associated with the dynamic operation of the vehicle 102. The vehicle dynamic data may include but may not be limited to the speed, acceleration, braking, steering, handling, mileage, mileage breakdown with respect to acceleration and braking, suspension wear, wheel wear, tire wear, break wear, battery wear, engine wear, exhaust system wear, steering system wear, and the like with respect to the dynamic operation of the vehicle 102 during one or more periods of time (e.g., from the beginning of the ownership period/lease term to a current point in time, from the beginning of the ownership period/lease term to the expiration of the ownership period/lease term).

The various types of vehicle utilization data may also pertain to vehicle safety data associated with the safe operation of the vehicle 102 during one or more periods of time. The safety data may pertain to a utilization of seat belts (not shown) by a one or more drivers of the vehicle 102 during operation of the vehicle 102 during the ownership period or lease term of the vehicle 102 by the individual 112. The safety data may also pertain to an alertness of the driver(s) during operation of the vehicle 102. The alertness of the driver(s) may be related to how alert, awake, and active the driver(s) during operation of the vehicle 102. The safety data may additionally pertain to an awareness of the driver(s) during operation of the vehicle 102. The awareness of the driver 112 may be related to how attentive and focused the driver 112 is with respect to driving related tasks during operation of the vehicle 102.

The various types of vehicle utilization data may additionally pertain to vehicle maintenance and repair data associated with the individual's maintenance of the vehicle 102, which may include, but may not be limited to, preventive maintenance of one or more components of the vehicle 102, timely regular component maintenance of one or more respective components of the vehicle 102 (e.g., timely oil and oil filter change of the vehicle 102, timely brake maintenance of the vehicle 102, timely tire maintenance of the vehicle 102, timely battery replacement of the vehicle 102, etc.), a number of insurance claims and purposes of the insurance claims associated with repair of the vehicle 102, a number of auto body shop visits and purposes of the auto body shop visits associated with the repair of the vehicle 102, a number of service shop (e.g., mechanical repair shops, dealer service shops) visits and purposes of the service shop visits associated with the repair of electronic components and/or mechanical components of the vehicle 102, and the like during one or more periods of time. It is to be appreciated that additional types of sensor data and/or data communicated by one or more external computing systems may be received and analyzed by the application 110 as vehicle utilization data.

As discussed in more detail below, the vehicle reliability application 110 may be configured to store the vehicle utilization data within respective data logs 124-128 that are each associated with respective types of vehicle utilization data. In one or more embodiments, the vehicle utilization data received during one or more periods of time may be retrieved from the respective data logs 124-128 and analyzed to electronically determine respective reliability scores that are associated with each of the utilization categories associated with reliability rankings of the vehicle 102.

In or more embodiments, the reliability scores maybe computed as values that may be processed between 0.01 and 10.0 such that a reliability score of 10.0 may be a highest allotted reliability score that may pertain to a most reliable utilization and a score of 0.01 may be a lowest allotted reliability score that may pertain to a least reliable utilization. However, it is to be appreciated that the reliability scores may be processed in and between additional value sets (e.g., 1-100) and/or as classifications (e.g., poor, fair, good, excellent).

In an exemplary embodiment, a reliability score may be associated to the driving performance category based on the dynamic operation of the vehicle 102 and/or the safe operation of the vehicle 102. The reliability scores assigned to the mileage category and the wear and tear category may be based on the dynamic operation of the vehicle 102. Additionally, the reliability score assigned to the maintenance and repair category may be based on the vehicle maintenance and repair data associated with the individual's maintenance of the vehicle 102 over one or more periods of time.

As discussed below, the reliability scores that are assigned to each of the utilization categories may be compared to reliability scores of the respective utilization categories that have been assigned to additional vehicles that are available within the vehicle resale marketplace to process and output percentile rankings that are associated with each of the utilization categories of the vehicle 102. Upon processing and outputting the percentile rankings of each of the utilization categories of the vehicle 102 in comparison to the additional vehicles in the vehicle resale marketplace, the vehicle reliability application 110 may process and reliability report associated with the vehicle 102. The vehicle reliability application 110 may further populate the respective percentile rankings of each of the utilization categories within the reliability report to be analyzed by consumers in the pre-owned vehicle marketplace, vehicle dealers, the OEM 104, and/or third-party entities to determine the reliability of the vehicle 102 in comparison to additional vehicles that may be available in the vehicle resale marketplace.

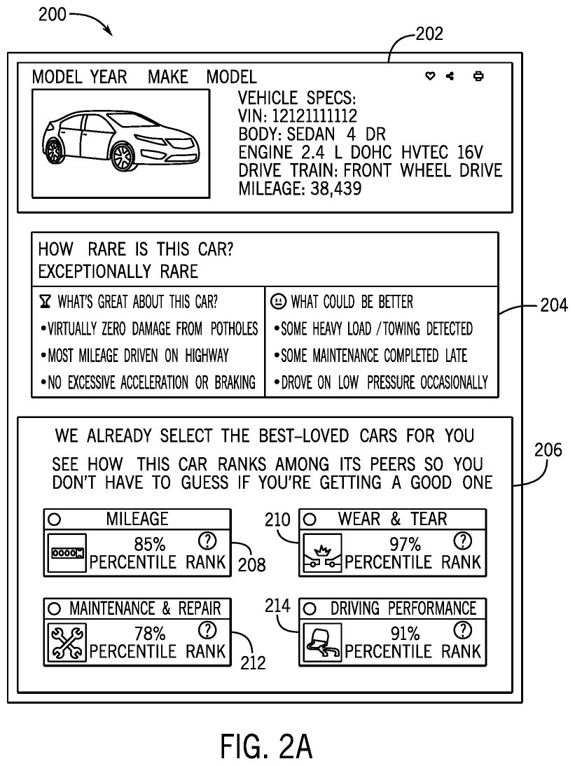

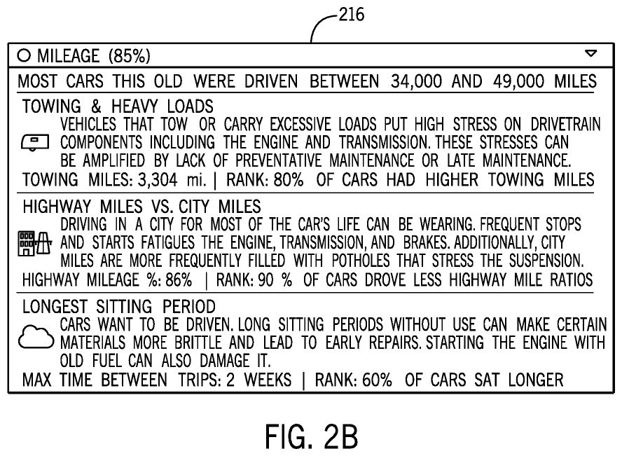

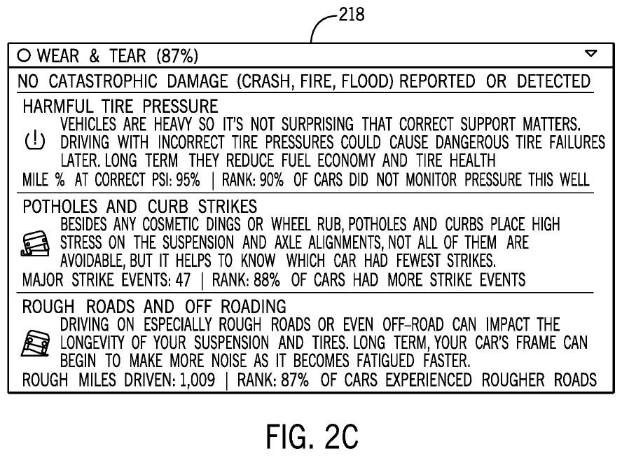

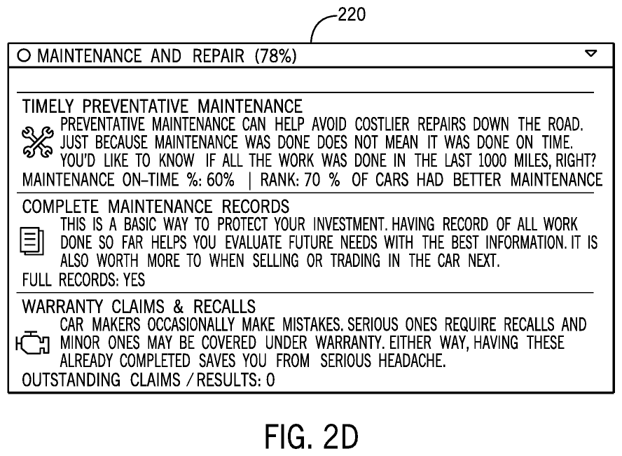

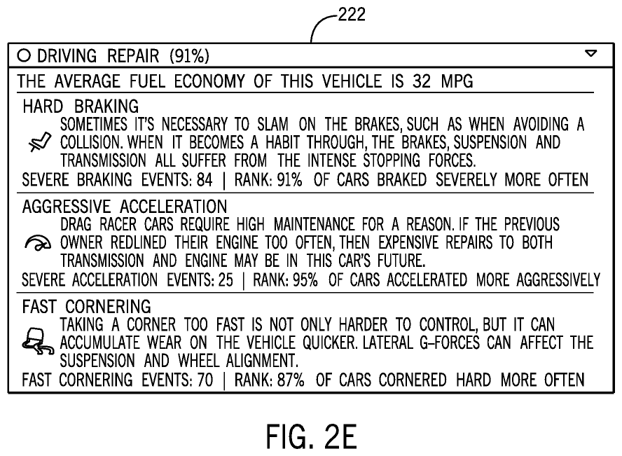

FIG. 2A is an illustrative example of a reliability report 200 processed by the vehicle reliability application 110 according to an exemplary embodiment of the present disclosure. As shown, in one embodiment, the reliability report 200 may be processed and presented in the form of a human machine interface (HMI) to be presented to consumers, vehicle dealers, the OEM, and/or third party entities through respective computing systems (not shown) (e.g., respective computing infrastructure, portable electronic devices, and the like). The reliability report 200 may be presented to include a vehicle description section 202 that provides a manufacturer/brand (make), model, trim, and model year of the vehicle 102, a photograph of the vehicle 102 (that may be taken by a vehicle dealer, individual, or third-party entity), vehicle specifications of the vehicle 102 (e.g., VIN, body style, engine type, drive train, mileage, color, etc.), and the like.

The reliability report 200 may include a vehicle overview section 204 that may be populated by the vehicle reliability application 110 with pre-stored classifications that may be selected based on the vehicle dynamic data and/or vehicle utilization data that may be received by the vehicle reliability application 110. Additionally, the vehicle overview section 204 may be populated with the pre-stored classifications based on the reliability scores that may be respectively assigned to each of the utilization categories of the vehicle 102 and/or the reliability rankings associated with each of the utilization categories of the vehicle 102. As shown, in some embodiments, the pre-stored classifications that may be presented in the vehicle overview section 204 may pertain to positive and/or negative classifications that may be associated with the utilization of the vehicle 102 during the ownership period or lease term of the vehicle 102 by the individual 112.

In an exemplary embodiment, the reliability report 200 may include a vehicle reliability rankings section 206 that may be populated with the respective percentile rankings associated with each of the utilization categories, as determined by the vehicle reliability application 110. Accordingly, each utilization category may be associated with a reliability ranking that is provided and presented as a percentile ranking that pertains to the ranking of the vehicle 102 in that particular utilization category in comparison to one or more subset of vehicles that may be available for resale in the vehicle resale marketplace. The one or more subsets of vehicles may include vehicles that are available within the vehicle resale marketplace that are being sold in a particular location (e.g., metropolitan area, county, state), a particular region (e.g., Northeast, Midwest, South East, South, Southwest, West), and/or a particular country.

In additional embodiments, the reliability rankings may be determined in comparison to one or more subsets of vehicles of a particular make, a particular model year range, a particular model range, a particular trim level range, a particular vehicle classification range (e.g., sedan, coupe, SUV), an engine size/level range, and the like. In one embodiment, the vehicle reliability application 110 may be configured to allow consumers, dealers, the OEM, and/or third party entities to select one or more types, locations, and/or classifications of additional vehicles by which the utilization categories of the vehicle 102 are ranked by reliability. Accordingly, the reliability rankings provided within the reliability report 200 may be provided based on the subjective requirements of particular consumers, dealers, third party entities, and/or the OEM 104.

In one or more embodiments, each of the reliability rankings may be presented as user interface input icons 208-214 that may be respectively inputted by a user to present respective utilization category information interfaces. As shown in FIGS. 2B-2E, each of the user interface input icons 208-214 may be inputted to present respective utilization category information interfaces 216-222. The vehicle reliability application 110 may be configured to determine underlying information from the vehicle utilization data received during one or more periods of time from the respective data logs 124-128. Such underlying information may pertain to details associated with specific vehicle utilization data that may provide explanation and/or specific details related to certain data points that may be extracted from the vehicle utilization data.

Accordingly, upon input of a respective user interface input icons 208-214 that may pertain to a respective utilization category reliability rating, the vehicle reliability application 110 may present the respective utilization category information interface 216-222. As shown in in FIGS. 2B-2E, the utilization category information interface 216-222 may be presented with the underlying information that may pertain to details associated with specific vehicle utilization data that may provide explanation and/or specific details related to certain data points that may be extracted from the vehicle utilization data for the respective utilization category. This may provide the OEM 104, one or more vehicle dealerships, and/or or third-party entities with specific information that may be analyzed to understand one or more reasons behind the determination of a particular reliability score and/or particular reliability ranking that may be associated with a respective utilization category.

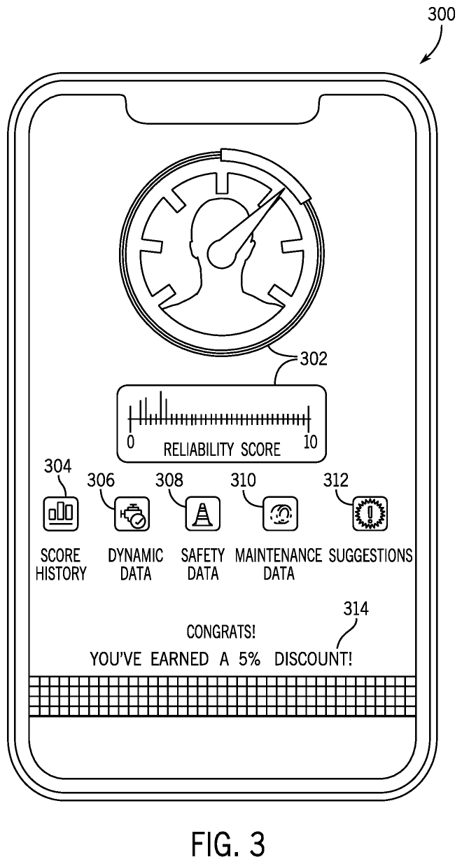

As discussed above, the vehicle reliability application 110 may be configured to promote a higher quality utilization of the vehicle 102 by the individual 112 who owns or who is leasing the vehicle 102 prior to the vehicle 102 being made available within the vehicle resale market. With particular reference to FIG. 3, the vehicle reliability application 110 may be configured to present a HMI in the form of a vehicle reliability user interface 300 to the individual 112 through the vehicle 102 and/or through a portable device 116 that may be used by the individual 112. In one configuration, the vehicle reliability user interface 300 may present reliability scores associated with utilization categories of the vehicle 102 in one or more graphical formats 302. In addition to presenting the reliability scores associated with the utilization categories, the vehicle reliability user interface 300 may be configured to present a reliability scores tracker user interface input icon 304 upon the vehicle reliability user interface 300.

The input of the reliability scores tracker user interface input icon 304 may enable the vehicle reliability application 110 to present a reliability scores historical tracker user interface (not shown) to the individual 112. In one configuration, the reliability score historical tracker user interface may present one or more historical views of the reliability scores that have been processed and stored by the application 110 at one or more points in time throughout the course of the ownership period or lease term of the vehicle 102 (i.e., from the beginning of the ownership period/lease term until a current point in time or end of the ownership period/lease term). The reliability score historical tracker user interface may present reliability scores in one or more graphical formats, including, but not limited to, line graphs, bar graphs, charts, and/or images to present one or more reliability scores that have been determined by the application 110 at one or more points in time over the course of the ownership period or the lease term (e.g., reliability scores presented as processed during each month of the ownership period/lease term).

Additionally, historical vehicle utilization data may be presented to the individual 112 in the form of dynamic data, safety data, and/or maintenance data that may be presented based on the input of one or more respective user interface input icons 306-310. In one or more configurations, the vehicle reliability application 110 may present the vehicle reliability user interface 300 with a suggestion user interface input icon 312 that may be inputted by the individual 112 to receive one or more operating suggestions that may be implemented to assist in increasing the reliability scores associated with one or more respective utilization categories at one or more points in time (e.g., prior to an end of an ownership period/lease term of the vehicle 102).

With continued reference to FIG. 1, the vehicle reliability application 110 may be configured to analyze the processed reliability scores associated with each of the utilization categories to determine one or more monetary values that may be associated with the vehicle 102. The vehicle reliability application 110 may selectively communicate the one or more monetary values to one or more consumers, the individual 112, one or more vehicle dealers, and/or one or more third-parties based on specific access privileges that may be determined by the OEM 104, one or more vehicle dealerships, and/or one or more third party entities.

The one or more monetary values may include, but may not be limited to, a residual value of the vehicle 102 that has been leased, an estimated resale value of the vehicle 102, an estimated cost to the OEM 104 to certify the vehicle 102 as a certified pre-owned vehicle that is included with certified pre-owned vehicle OEM warranty, and/or a discount that may be calculated and associated with the individual 112 towards the lease or purchase of another vehicle from the OEM 104.

In one configuration, the residual value of the vehicle 102 (that has been leased) and an estimated resale value of the vehicle 102 may be processed based on the reliability scores associated with the utilization categories of the vehicle 102. Accordingly, the reliability scores assigned to the driving performance category, the mileage category, the wear and tear category, and/or the maintenance and repair category may directly influence the estimated resale value of the vehicle 102 and/or the residual value of the vehicle 102. For example, higher reliability scores for one or more of the utilization categories may directly influence the computation of a higher estimated resale value of the vehicle 102.

In one or more embodiments, the computation of the estimated resale value and/or the residual value may also be influenced based on a manufacturer's suggested retail price (MSRP) of the vehicle 102 when the vehicle 102 was initially purchased or leased, a market value of the vehicle 102 (e.g., a resale value or trade-in value of the vehicle 102 at the end of the ownership period or lease term of the vehicle 102), and/or additional market factors, that may include, but may not be limited to, if the model of the vehicle 102 has been redesigned and/or significantly changed (e.g., body style change, engine redesign), if the model of the vehicle 102 has been discontinued, a supply of the model/model year of the vehicle 102, a demand for the model/model year of the vehicle 102, and the like.

Upon computing the estimated resale value and/or the residual value of the vehicle 102, the vehicle reliability application 110 may be configured to compute a discount that may be associated with the individual 112 for purchasing or leasing another vehicle (e.g., a subsequent vehicle) through the OEM 104. The discount may apply to a purchase price and/or a down payment associated with the purchase of another vehicle through the OEM 104. The discount may additionally or alternatively apply to lease payments or a down payment associated with the lease of another vehicle through the OEM 104. The discount may be dynamically computed and may change based on changes to the reliability scores as they are dynamically assigned to each of the operational categories from the beginning until the end of the ownership period or the lease term of the vehicle 102.

As shown in the illustrative embodiment of FIG. 3, the discount 314 may be presented to the individual 112 through the vehicle reliability user interface 300 to further incentivize the individual 112 to improve the operation of the vehicle 102 during the ownership period or the lease term. Additionally, the discount 314 may be presented to the individual 112 through the vehicle reliability user interface 300 to further incentivize the individual 112 to purchase or lease another vehicle through the OEM 104 upon the completion of the ownership period or the expiration of the lease term of the vehicle 102. This functionality may be provided to promote continued brand loyalty with respect to the OEM 104.

In one embodiment, the vehicle reliability application 110 may be configured to analyze the respective reliability scores that are assigned with each of the utilization categories and/or the reliability rankings of each of the utilization categories (e.g., that may be determined during the resale of the vehicle 102) to estimate a cost to the OEM 104 to certify the vehicle 102 as a certified pre-owned vehicle that is included with certified pre-owned vehicle OEM warranty. The estimated cost to the OEM 104 to certify the vehicle 102 may be based on a baseline warranty cost to certify the vehicle 102 based on its make, model year, model, drive train, trim level, etc. in addition to projected costs that may be estimated to remediate any potential electrical and/or mechanical issues during a duration of a potential certified pre-owned warranty term that may be projected based on reliability rankings that may be associated with the utilization categories of the vehicle 102.

In particular, the estimated cost to the OEM 104 to certify the vehicle 102 may be based on the reliability rankings and reliability scores of particular factors pertaining to the driving performance category, the mileage category, the wear and tear category, and/or the maintenance and repair category of the vehicle 102 that may be analyzed to project a monetary value that may be output by the vehicle reliability application 110 and that may be aggregated with the baseline warranty cost to certify the vehicle 102 based on its make, model year, model, drive train, trim level, etc. In certain circumstances, the OEM 104 may utilize the estimated cost to the OEM to certify the vehicle 102 to subjectively charge one or more vehicle dealers a customized price to certify the vehicle 102 in order for the vehicle dealer(s) to sell the vehicle 102 as a certified pre-owned vehicle that is offered with a certified pre-owned warranty. For example, if the reliability rankings associated with the utilization categories of the vehicle 102 are lower, the estimated cost to the OEM to certify the vehicle 102 may be higher which may consequently enable the OEM 104 to charge a vehicle dealer a higher monetary amount to certify the vehicle 102 as a certified pre-owned vehicle.

As discussed below, the vehicle reliability application 110 may also be configured to store a vehicle resale reliability log 144. The vehicle resale reliability log 144 may be configured as a log of vehicles that may be available for resale through the OEM 104, one or more vehicle dealerships, and/or one or more third-parties. The vehicle resale reliability log 144 may serve as a data repository for reliability scores that are associated with the utilization categories of the respective vehicles that are available for resale in the vehicle resale marketplace and that are utilizing the vehicle reliability application 110. The vehicle resale reliability log 144 may also be populated with vehicle specification information that may include, but may not be limited to, the make of vehicles, the models of vehicles, the model years of vehicles, the city, state, region, country in which each respective vehicle has been primarily utilized and/or is being resold, the mileage of each respective vehicle, the driver train of each particular vehicle, the body style of each particular vehicle, the trim level of each particular vehicle, and the like.

Additionally, the vehicle resale reliability log 144 may include a real-time categorization of each of the vehicles that are available for resale that may be based on reliability scores assigned to the utilization categories of the respective vehicles. For example the real-time categorization may pertain to resale conditions (e.g., excellent condition, good condition, fair condition, poor condition) with respect to the resale of respective vehicles. As discussed below, in one embodiment, upon assigning the reliability scores of each of the utilization categories, the vehicle reliability application 110 may be configured to access the vehicle resale reliability log 144 to determine reliability scores that are assigned to utilization categories of one or more subsets of vehicles that are available for resale in the vehicle resale marketplace.

The vehicle reliability application 110 may thereby compare the reliability scores assigned to the utilization categories of the vehicle 102 to the reliability scores of the utilization categories of the one or more subsets of vehicles that are available for resale and may thereby output reliability rankings that are associated with each of the utilization categories of the vehicle 102. As discussed, the reliability rankings may be outputted as percentile rankings that may provide a specific percentile that is associated with each particular reliability score of each utilization category of the vehicle 102. Upon processing the reliability ranking that is associated with each utilization category of the vehicle 102, the vehicle reliability application 110 may be configured to populate the reliability rankings into the reliability report 200 to be communicated to the OEM 104, one or more vehicle dealerships, and/or one or more third-parties.

In some configurations, the vehicle resale reliability log 144 may also store vehicle lease inventory information that may be associated with vehicles that may be currently being leased out by the OEM 104 and may be available for resale upon the end of their respective lease terms. The vehicle lease inventory information may also include information associated with the lease terms of each of the vehicles leased through the OEM 104. Such information may include, but may not be limited to, lease term start dates, lease term end dates, a current mileage of the vehicles, and/or additional operational statistics associated with each respective vehicles as they are being leased. Additionally, the vehicle lease inventory information may include a real-time categorization of the list of vehicles that are being leased through the OEM 104 that may be based on respective residual value of the vehicles and/or reliability scores associated with the utilization categories of the vehicles leased by the OEM 104.

In one embodiment, the vehicle reliability application 110 may communicate vehicle lease inventory information from the vehicle resale reliability log 144 to the OEM 104 and/or vehicle dealerships to enable the OEM 104 and/or vehicle dealerships to forecast the number of leased vehicles, types of leased vehicles and/or conditions of the leased vehicles that are currently leased through the OEM 104 and that may be made available within the vehicle resale marketplace upon the end of respective lease terms. This functionality may allow the OEM 104 and/or vehicle dealerships to forecast a number of type of vehicles that may be available for resale and/or to be certified as certified pre-owned vehicles at one or more future points in time.

With continued reference to FIG. 1, the ECU 106 of the vehicle 102 may be configured to execute one or more applications including but not limited to the vehicle reliability application 110. The ECU 106 may also be configured to execute one or more operating systems, vehicle system and subsystem executable instructions, vehicle sensor logic, and the like. In one or more embodiments, the ECU 106 may include a microprocessor, one or more application-specific integrated circuit(s) (ASIC), or other similar devices.

The ECU 106 may also include respective internal processing memory, an interface circuit, and bus lines for transferring data, sending commands, and communicating with the plurality of components of the vehicle 102. In one or more configurations, the ECU 106 may include a respective communication device (not shown) for sending data internally to components of the vehicle 102 and communicating with externally hosted computing systems (not shown) (e.g., external to the vehicle 102).

In an exemplary embodiment, the ECU 106 may be operably connected to a head unit 118 of the vehicle 102. In one embodiment, the head unit 118 may operably control and may be operably connected to a display unit (not shown) within the vehicle 102. The head unit 118 may be configured to execute one or more applications, application interfaces, and/or to communicate with one or more components of the vehicle 102 to provide one or more interfaces to the individual 112 within the vehicle 102 through the display unit.

In one or more embodiments, the vehicle reliability application 110 may be configured to present the HMI in the form of one or more user interfaces to the individual 112 through the display unit of the head unit 118 and/or a display screen (not shown) of the portable device 116 that may be used by the individual 112. For example, the vehicle reliability application 110 may be configured to present the vehicle reliability user interface 300 and one or more related application user interfaces through the head unit 118 and/or through the portable device 116 to be accessed by the individual 112.

In an exemplary embodiment, the ECU 106 and the head unit 118 may be operably connected to a storage unit 120 of the vehicle 102. The ECU 106 and/or the head unit 118 may communicate with the storage unit 120 to execute one or more applications, operating systems, vehicle systems and subsystem user interfaces, and the like that are stored on the storage unit 120. In one embodiment, the vehicle reliability application 110 may be configured to present a user setup user interface (not shown) upon an initial use of the application 110 and/or upon the initiation of the lease term of the vehicle 102. The user setup user interface may enable the individual 112, the OEM 104, and/or one or more vehicle dealerships to setup a user profile 122 that may associated with the individual 112 and/or the vehicle 102 and may be stored upon the storage unit 120.

In particular, the user setup user interface may be presented with user interface input fields that may enable the individual 112, the OEM 104, and/or the vehicle dealership(s) to populate the user profile 122 with user related data and vehicle related data that may be used to identify the individual 112 and associate the individual 112 with the vehicle 102. The user profile 122 may be populated with user related data that may include a name of the individual 112, contact information associated with the individual 112, a start date of ownership of the vehicle 102 or a term of the lease of the vehicle 102, and the like. The user profile 122 may also be populated with driver related data that may include names of one or more drivers of the vehicle 102 and additional information (e.g., license numbers) associated with one or more drivers of the vehicle 102. The user profile 122 may also be populated with vehicle related data that may include a vehicle identification number (VIN) of the vehicle 102, the dealership from which the vehicle 102 was purchased or leased, the current mileage of the vehicle 102, and/or additional operational statistics associated with the vehicle 102. The vehicle related data may also include, but may not be limited to, a current mileage (e.g., total miles driven) of the vehicle 102, vehicle system and subsystem data, and/or vehicle sensor data.

In an exemplary embodiment, in addition the storing the user profile 122, the storage unit 120 may be configured to store a dynamic data log 124, a safety data log 126, and a maintenance data log 128. The data logs 124-128 may be configured as relational databases that may be configured to store respective vehicle utilization data in the form of vehicle dynamic data, vehicle safety data, and vehicle maintenance data that are respectively associated with the dynamic operation of the vehicle 102, the safe operation of the vehicle 102, and the maintenance of the vehicle 102 during the lease term of the vehicle 102.

In one configuration, the dynamic data log 124 may be configured to include numerous records that may store various categories of vehicle dynamic data that may be received by the vehicle reliability application 110 from vehicle dynamic sensors 130 of the vehicle 102. The various categories of vehicle dynamic data may include, but may not be limited to, data that pertains to a position of the vehicle 102, a heading of the vehicle 102, a velocity of the vehicle 102, a steering angle of a steering of the vehicle 102, a current steering speed associated with the steering of the vehicle 102, a current throttle angle of a throttle of the vehicle 102, a current acceleration of the vehicle 102, a current yaw rate of the vehicle 102, a current brake force associated with the brakes of the vehicle 102, a current transmission gear of the vehicle 102, a current geo-location of the vehicle 102, and the like that may be sensed at one or more points in time.

The various categories of vehicle dynamic data may also pertain to the wear and tear sensed with respect to various vehicle components that may include, but may not be limited to, suspension wear, wheel wear, tire wear, break wear, battery wear, engine wear, exhaust system wear, steering system wear, and the like. In one embodiment, the vehicle dynamic sensors 130 may be configured to receive inputs from one or more vehicle systems, sub-systems, control systems, and the like. The vehicle dynamic sensors 130 may be included as part of a Controller Area Network (CAN) of the vehicle 102 and may be configured to provide vehicle dynamic data to the ECU 106 to be utilized for one or more vehicle systems, sub-systems, control systems, and the like. The vehicle dynamic sensors 130 may include, but may not be limited to, position sensors, heading sensors, speed sensors, steering speed sensors, steering angle sensors, throttle angle sensors, accelerometers, magnetometers, gyroscopes, yaw rate sensors, brake force sensors, wheel speed sensors, wheel turning angle sensors, transmission gear sensors, temperature sensors, RPM sensors, GPS/DGPS sensors, and the like (individual sensors not shown).

In one configuration, the vehicle dynamic sensors 130 may output the vehicle dynamic data to the vehicle reliability application 110. The vehicle dynamic data may include one or more values (e.g., numeric levels) that are associated with the real-time dynamic performance of the vehicle 102 as the vehicle 102 is being operated (e.g., driven) during the ownership period or the lease term. In one embodiment, upon receipt of the vehicle dynamic data from the vehicle dynamic sensors 130, the vehicle reliability application 110 may be configured to communicate with the ECU 106 (e.g., system clock of the ECU 106) to determine a timestamp that may be associated with a time of receipt of the vehicle dynamic data. The vehicle reliability application 110 may also be configured to store respective categories of vehicle dynamic data within respective records of the dynamic data log 124 in addition to the timestamp that may be associated with the time of receipt of the vehicle dynamic data.

Vehicle dynamic data that may be received at one or more points in time may be retrieved from the dynamic data log 124 to determine the reliability scores that may be associated with one or more utilization categories of the vehicle 102. In one embodiment, the vehicle dynamic data may be analyzed against dynamic thresholds that may be associated with respective categories of dynamic data (e.g., high speed threshold, high acceleration threshold, high braking rate threshold, etc.) that may classify the dynamic operation of the vehicle 102 over a period of time. In one embodiment, the dynamic operation of the vehicle 102 may be classified as being poor, fair, good, or excellent based on the vehicle dynamic data retrieved from the dynamic data log 124. For example, if the vehicle dynamic data indicates that the vehicle 102 has been driven for a period of time with an average acceleration, average speed, and/or average braking rate that are a particular amount over the respective thresholds, the dynamic operation of the vehicle 102 may be accordingly classified as poor or fair.

In an exemplary embodiment, the safety data log 126 may be configured to include numerous records that may store various categories of vehicle safety data associated with the safe operation of the vehicle 102. The categories of vehicle safety data may include, but may not be limited to utilization of seat belts by the driver(s) during operation of the vehicle 102, alertness of the driver(s) during operation of the vehicle 102, and/or awareness of the driver(s) during operation of the vehicle 102. The records of the safety data log 126 may be populated based on vehicle safety data that may be received from vehicle safety sensors 132 of the vehicle 102. In one configuration, the vehicle safety sensors 132 may be disposed at one or more portions of an interior cabin (not shown) of the vehicle 102 to sense the data associated with a safe operation of the vehicle 102.

The vehicle safety sensors 132 may be configured as image sensors (e.g., cameras) that may be configured to capture images of the driver(s) as the vehicle 102 is driven. For example, the image sensors may be configured to capture the each driver's eye gaze, head movements, body movements, and the like and may output safety data that may be analyzed to determine each driver's seat belt usage, a level of alertness, and/or a level of awareness during operation of the vehicle 102 during the ownership period or lease term of the vehicle 102. The vehicle safety sensors 132 may also be configured as capacitive sensors, touch sensors, pressure sensors, and/or latch sensors that may be disposed upon a seatbelt of a driver's seat (not shown) of the vehicle 102, a seatbelt latch (not shown), a steering wheel (not shown) of the vehicle 102, and/or additional interior components of the vehicle 102 (e.g., gear shifter, display unit). Safety data output from such sensors may also be analyzed to determine each driver's seat belt usage, a level of alertness of each drier, and/or a level of awareness of each driver during operation of the vehicle 102.

In one configuration, the vehicle safety sensors 132 may be configured to execute sensor logic (e.g., image logic, touch sensor logic) that may be analyzed to determine each driver's seat belt usage, a level of alertness of each driver, and/or a level of awareness of each driver of the vehicle 102 to output vehicle safety data based to the vehicle reliability application 110. For example, safety data pertaining to images of each driver's movements pertaining to using or not using the seatbelt, each driver's eye gaze, and/or each driver's head positions may be analyzed by executing the sensor logic to determine each driver's seat belt usage, the level of alertness of each driver, and/or the level of awareness of each driver during operation of the vehicle 102 during the ownership period or lease term of the vehicle 102 by the individual 112.

The vehicle safety data outputted to the vehicle reliability application 110 by the vehicle safety sensors 132 may include values associated with each driver's use of the seatbelt, the alertness of each driver, and/or the awareness of each driver 112 as the vehicle 102 is being operated by each respective driver. In particular, the vehicle safety data may include a value (0-5 value, 0 being no usage of the seatbelt, 5 being consistent usage of the seatbelt) that may pertain to each driver's use of the seatbelt during operation of the vehicle 102 during a particular period of time. The vehicle safety data may also include a value that may pertain to the alertness of the each driver during the operation of the vehicle 102 (e.g., 1-5 value, 1 being drowsy, 5 being very alert) during a particular period of time. Additionally, the vehicle safety data may include a value that may pertain to the awareness of each driver during operation of the vehicle 102 (e.g., 1-5 value, 1 being highly distracted during operation of the vehicle 102, 5 being very aware and attentive during operation of the vehicle 102).

In one embodiment, upon receipt of the vehicle safety data from the vehicle safety sensors 132, the vehicle reliability application 110 may be configured to communicate with the ECU 106 to determine a timestamp that may be associated with a time of receipt of the vehicle safety data. The vehicle reliability application 110 may also be configured to store respective categories of vehicle safety data within respective records of the dynamic data log 124 in addition to the timestamp that may be associated with a time of receipt of the vehicle safety data.

As discussed below, the vehicle safety data that may be received at one or more points in time may be retrieved from the safety data log 126 by the vehicle reliability application 110 to determine the reliability scores that may be associated with one or more utilization categories of the vehicle 102. In one embodiment, the vehicle safety data may be analyzed by the vehicle reliability application 110 against safety thresholds that may be associated with respective categories of dynamic data (e.g., seatbelt usage threshold, alertness threshold, awareness threshold, etc.). In one embodiment, the safe operation of the vehicle 102 may be classified as being poor, fair, good, or excellent based on the vehicle safety data retrieved from the safety data log 126.

In one or more embodiments, the maintenance data log 128 may be configured to include numerous records that may store various categories of vehicle maintenance data that may be received by the vehicle reliability application 110 from vehicle maintenance sensors 134 of the vehicle 102 and/or from the vehicle data computing infrastructure 114. In one embodiment, the vehicle maintenance sensors 134 may be configured to receive inputs from one or more vehicle components, systems, sub-systems, control systems, and the like.

The vehicle maintenance sensors 134 may include, but may not be limited to, tire pressure sensors, fuel level sensors, oil level sensors, oil filter sensors, air filter sensors, transmission sensors, battery power level sensors, headlight sensors, wiper sensors, and the like that may be configured to determine error codes, maintenance issues, maintenance updates, and/or required repairs that may be recommended and/or required with respect to one or more respective electrical, mechanical, and/or structural components (e.g., parts, filters, belts, electrical sensors, etc.) of the vehicle 102. In particular, the vehicle maintenance sensors 134 may be configured to execute sensor logic to analyze data associated with error codes, maintenance issues, maintenance updates, and/or required repairs and may output maintenance values.

The maintenance values may pertain to a remediation or non-remediation of error codes, maintenance issues, maintenance updates, and/or required repairs. Additionally when applicable, the maintenance values may pertain to an amount of time that may pass between an initial notification of the error codes, maintenance issues, maintenance updates, and/or required repairs to the individual 112 (e.g., through the head unit 118 and/or various vehicle dashboard, audio, and visual alerts) and the remediation of the respective codes, issues, updates, and/or repairs.

Stated differently, the maintenance values may be determined based on an evaluation of a timely maintenance of each respective vehicle component. The evaluation of the timely maintenance may be based on if error codes, maintenance issues, maintenance updates, and/or required repairs are remediated. The evaluation of the timely maintenance may also be based on a difference in time between an initial sensing of error codes, maintenance issues, maintenance updates, and/or required repairs and a sensing of a remediation of the codes, issues, updates, and/or repairs with respect to one or more components of the vehicle 102. For example, the maintenance values output by the vehicle maintenance sensors 134 may include 1-5 values where a value of 1 may indicate a lack of response or an untimely remediation response and a value of 5 may indicate a timely (e.g., within a predetermined timeframe) remediation response to one or more error codes, maintenance issues, maintenance updates, and/or required repairs with respect to one or more electrical, mechanical, and/or structural components of the vehicle 102.

In one or more embodiments, the vehicle reliability application 110 may additionally be configured to communicate with the vehicle data computing infrastructure 114 to receive vehicle maintenance data that may be include, but may not be limited to a number of insurance claims and purposes for the insurance claims related to the vehicle 102, a number of auto body shop visits and purposes of the auto body shop visits related to the vehicle 102, number of service shop visits and purposes of the service body shop visits related to the vehicle 102.

The vehicle data computing infrastructure 114 may be maintained by the OEM 104, one or more third-parties (e.g., regulatory agencies, road side service agencies, insurance agencies, etc.) and may be populated with data from traffic regulatory agencies (e.g., DMV), insurance companies, auto-body shops, vehicle dealerships, vehicle service shops, and the like. The vehicle data computing infrastructure 114 may be configured to store subjective information associated with drivers of vehicles and respective vehicles including, but not limited to a number and purpose of insurance claims that may be associated with particular drivers and/or vehicles, a number and purpose of body shop visits, service shop visits, and the like that may be associated with particular vehicles, a number and types of incidents (e.g., traffic violations, accidents) that may be associated with particular vehicles and/or drivers.

In one or more embodiments, the vehicle data computing infrastructure 114 may additionally be configured to store market data that may be populated by the OEM 104, one or more vehicle dealerships(s), and/or additional third party entities. The market data may pertain to various brands, models, model years, demand information, supply information, and the like. The market data may additionally include a market value of the various vehicle brands/models that may be based on a supply of the model/model year of the vehicle 102 and/or a demand for the model/model year of the vehicle 102. The market data may also include market factors such as if the models of particular vehicles have been redesigned and/or significantly changed at a particular point in time and/or if models of particular vehicles been discontinued at a particular point in time. In one embodiment, market data may be received by the application 110 from the vehicle data computing infrastructure 114 and may be utilized to estimate the resale value of the vehicle 102 and/or determine the residual value of the vehicle 102.

In one configuration, the vehicle reliability application 110 may be configured to provide a query using data included within the user profile 122 (e.g., vehicle VIN) to the vehicle data computing infrastructure 114 to obtain vehicle maintenance data that may be associated with the number of insurance claims, the number and purpose of body shop visits, the number and purpose of service shop visits that may be associated with the repair of damage (e.g., body damage), incidents that may be associated with the vehicle 102 and/or the maintenance and repair of components of the vehicle 102 during one or more periods of time.

In one embodiment, upon receipt of the vehicle maintenance data from the vehicle maintenance sensors 134 and/or the vehicle data computing infrastructure 114, the vehicle reliability application 110 may be configured to communicate with the ECU 106 to determine a timestamp that may be associated with a time of receipt of the vehicle maintenance data. The vehicle reliability application 110 may also be configured to store respective categories of vehicle maintenance data within respective records of the maintenance data log 128 in addition to respective timestamps.

In one or more embodiments, the vehicle maintenance data that is associated with one or more timeframes may be retrieved from the maintenance data log 128 to determine reliability scores that may be assigned to one or more utilization categories of the vehicle 102. In one embodiment, the vehicle maintenance data may be analyzed against maintenance thresholds that may be associated with respective categories of maintenance data (e.g., maintenance value threshold, insurance claim threshold, body-shop visit threshold, etc.) that may classify the maintenance of the vehicle 102 as being poor, fair, good, or excellent based on the vehicle maintenance data retrieved from the maintenance data log 128.

With continued reference to FIG. 1, the ECU 106 of the vehicle 102 may also be operably connected to a communication unit 136 of the vehicle 102. The communication unit 136 may be configured to communicate with one or more components of the operating environment 100 and/or additional systems and components outside of the operating environment 100. The communication unit 136 may include, but may not be limited to including, one or more transceivers (not shown) of the vehicle 102 and additional components (not shown) that may be utilized for wired and wireless computer connections and communications via various protocols with the portable device 116 that may be used by the individual 112 and may be located within a (predetermined) communicable range with the communication unit 136 of the vehicle 102. For example, the communication unit 136 may be utilized for wired and wireless computer connections that may include an active computer connection with the portable device 116 that may be previously paired to the vehicle 102.

In one embodiment, the communication unit 136 may be configured to communicate with the external server 108 through an internet cloud (not shown). The communication unit 136 may be configured to send and receive data that may be analyzed, accessed, and/or stored by the vehicle reliability application 110. For example, the communication unit 136 may be configured to send the vehicle dynamic data, the vehicle safety data, and/or the vehicle maintenance data that may be received at one or more points in time from the respective data logs 122-126 by the vehicle reliability application 110 to the external server 108.

With particular reference to the external server 108, in an exemplary embodiment, the external server 108 may include a processor 138 that may operably control one or more components of the external server 108. In some configurations, the processor 138 may be configured to execute the vehicle reliability application 110. The processor 138 may be operably connected to a communication unit 140 of the external server 108. The communication unit 140 may include one or more network interface cards (not shown) that may be configured to connect to one or more computing systems (e.g., through the internet cloud) including, but not limited to, the ECU 106 of the vehicle 102. In one embodiment, the communication unit 140 may be configured to send and receive data with the communication unit 136 of the vehicle 102 to facilitate exchange of vehicle utilization data and application data.

In one configuration, the processor 138 may be operably connected to a memory 142 of the external server 108. The memory 142 may be configured to store data files associated with one or more applications, operating systems, vehicle systems, subsystem user interfaces, including but not limited to data files of the vehicle reliability application 110. In particular, the memory 142 may be configured to store the vehicle resale reliability log 144. As discussed, the vehicle resale reliability log 144 may be configured as a relational database/data store that may include a plurality of records that may respectively pertain to a plurality of vehicles that may be available for resale in the market place. For example the vehicle resale reliability log 144 may be configured to include a record that may pertain to the vehicle 102 when it is available for resale upon the completion of the ownership period or lease term by the individual 112 in addition to records that may respectively pertain to additional vehicles that may available for resale in the vehicle resale marketplace.

In one embodiment, for each of the vehicles that are listed to be resold within the vehicle resale marketplace and that utilize the vehicle reliability application 110, the application 110 may be configured to access respective user profiles associated with the respective drivers of the vehicles. Upon accessing the respective user profiles, the application 110 may retrieve data associated with each respective vehicle specifications (e.g., VIN, brand, model, lease term, current mileage) and the driver of each respective vehicle (e.g., driver information, name, and contact information). The data associated with each vehicle and the driver of each vehicle may be populated within a respective record of the vehicle resale reliability log 144. For example, with respect to the vehicle 102, when the vehicle 102 is put into the vehicle resale market to be resold after the ownership period or lease term of the vehicle 102 by the individual 112, the vehicle reliability application 110 may be configured to access the user profile 122 stored on the storage unit 120 of the vehicle 102 to retrieve data associated with the vehicle 102 and the individual 112 (e.g., as the driver of the vehicle 102). The data associated with the vehicle 102 and the individual 112 may thereby be populated within a record of the vehicle resale reliability log 144 that is associated with the vehicle 102.

In one embodiment, each record of the vehicle resale reliability log 144 may also be populated with reliability scores that are associated each of the utilization categories of each of the vehicles to maintain a log of reliability scores for each of the vehicles that are in the vehicle resale marketplace to be retrieved by the vehicle reliability application 110. In other words, for each vehicle that is using the vehicle reliability application 110, the application 110 may be configured to assign reliability scores for each of the utilization categories. The vehicle reliability application 110 may thereby store the reliability stores for each of the vehicles upon the vehicle resale reliability log 144 to maintain a log of reliability scores that are associated with vehicles that are listed for resale within the vehicle resale marketplace.

In one or more embodiments, upon assigning the reliability scores for each of the utilization categories of the vehicle 102, the vehicle reliability application 110 may be configured to access the vehicle resale reliability log 144 to determine reliability rankings that may be associated with respective utilization categories of the vehicle 102. The vehicle reliability application 110 may be configured to retrieve the reliability scores that may be associated with respective utilization categories for one or more subsets of vehicles and compare them to the reliability scores assigned to the utilization categories of the vehicle 102 to determine reliability rankings in the form of percentile rankings of each of the respective utilization categories of the vehicle 102. As discussed above, the application 110 may populate the reliability report 200 with the respective reliability rankings as percentile rankings of each of the utilization categories. Accordingly, each utilization category may be associated with a reliability ranking that pertains to the ranking of the vehicle 102 in that particular utilization category in comparison to one or more subsets of vehicles that may be available for resale in the vehicle resale marketplace.

In one or more embodiments, the vehicle reliability application 110 may be configured to provide vehicle inventory data for one or more subsets of vehicles that are available for resale in the vehicle resale marketplace to the OEM 104 and/or one or more vehicle dealerships. In particular, the vehicle reliability application 110 may be configured to present a vehicle resale inventory user interface (not shown) that may present an inventory of pre-owned/leased vehicles that may be (currently) listed for resale one or more areas (e.g., cities, regions, counties, states, etc.) based on respective selections provided by the OEM 104 and/or one or more vehicle dealerships.

In some configurations, the vehicle resale inventory user interface may be presented through a computing infrastructure (not shown) that may be owned and/or operated by the OEM 104 and/or one or more vehicle dealerships. The vehicle inventory user interface may be selectively accessed by the OEM 104 and/or one or more vehicle dealerships to present selective vehicle information. Such selective vehicle information may include, but may not be limited to, the reliability rankings associated with the utilization categories of each vehicle available for resale, the brand/model of each vehicle available for resale, the model year of each vehicle available for resale, specifications (e.g., model trim) associated with each vehicle available for resale, the current mileage associated with each vehicle available for resale, and the like.

In one or more embodiments, the vehicle reliability application 110 may be configured to analyze the reliability rankings associated with each of the utilization categories and may determine a real-time classification of each of the vehicles that are available for resale within the vehicle resale marketplace. The real-time classification of each of the vehicles may pertain to resale conditions (e.g., excellent condition, good condition, fair condition, poor condition) with respect to the resale of respective vehicles through the OEM 104 and/or through one or more vehicle dealerships (e.g., as certified pre-owned vehicles).

In an exemplary embodiment, information may be presented through the vehicle resale user interface by the vehicle reliability application 110 may be based on a query of the vehicle resale reliability log 146. Accordingly, the OEM 104 and/or one or more vehicle dealers may be able to evaluate the reliability rankings associated with respective utilization categories of respective vehicles, the classifications of the vehicles available for resale in one or more areas (e.g., cities, regions, counties, states, etc.), and/or additional vehicle information (e.g., the current mileage of vehicles, the brand/model/model year of vehicles) for various planning purposes including financial planning, production planning, sales planning, and the like for one or more future points in time based on data that is stored upon the vehicle resale reliability log 146.

### II. The Vehicle Reliability Report Processing Application and Related Methods

The general functionality of the vehicle reliability application 110 will now be discussed in more detail with respect to the methods that may be executed by the application 110. In an exemplary embodiment, the vehicle reliability application 110 may be fully or partially executed by the processor 138 of the external server 108 and/or by the ECU 106 of the vehicle 102. The vehicle reliability application 110 may utilize the communication unit 136 of the vehicle 102 and the communication unit 140 of the external server 108 to communicate application related data back and forth from the vehicle 102 to the external server 108 and/or from the external server 108 to the vehicle 102 (e.g., through the internet cloud). Additionally, the vehicle reliability application 110 may utilize the communication unit 136 of the vehicle 102 and/or the communication unit 140 of the external server 108 to communicate application related data between the vehicle 102, the external server 108, and the vehicle data computing infrastructure 114.

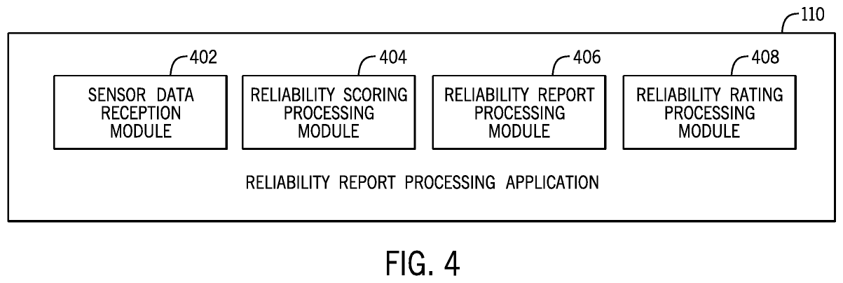

FIG. 4 is a schematic view of a plurality of modules 402-408 of the vehicle reliability application 110 for processing the reliability report 200 associated with the vehicle 102 according to an exemplary embodiment of the present disclosure. In an exemplary embodiment, the plurality of modules 402-408 may include a data reception module 402, a reliability scoring processing module 404, a reliability report processing module 406, and a reliability rating processing module 408. It is to be appreciated that the vehicle reliability application 110 may include one or more additional modules and/or sub-modules that are included in addition or in lieu of the modules 402-408.

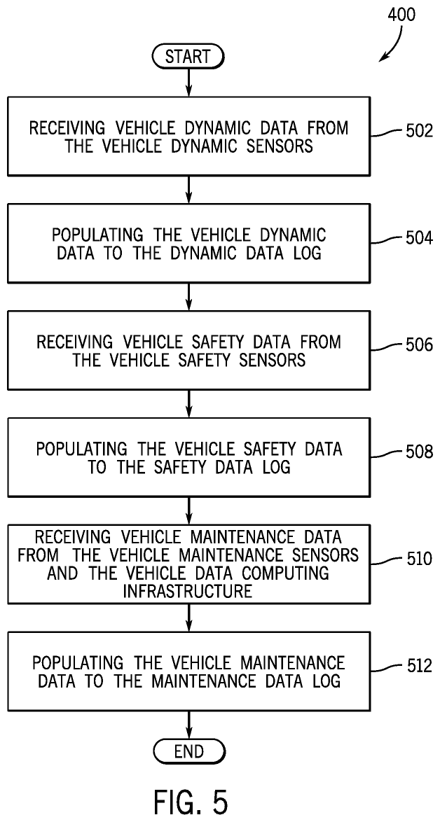

FIG. 5 is a process flow diagram of a method 500 for populating data logs 124-128 with vehicle utilization data during an ownership period or a lease term of the vehicle 102 according to an exemplary embodiment of the present disclosure. FIG. 5 will be described with reference to the components of FIG. 1-FIG. 4, though it is to be appreciated that the method 500 of FIG. 5 may be used with additional and/or alternative system components. It is appreciated that the method 500 of FIG. 5 may be continually executed by vehicle reliability application 110 during each operation of the vehicle 102 during the duration of the ownership period of the lease term of the vehicle 102.

The method 500 may begin at block 502, wherein the method 500 may include receiving vehicle dynamic data from the vehicle dynamic sensors 130. In an exemplary embodiment, the data reception module 402 of the vehicle reliability application 110 may be configured to communicate with the ECU 106 of the vehicle 102 to receive sensor data from the sensors 130-134 of the vehicle 102. Additionally, the data reception module 402 may be configured to utilize the communication unit 140 of the external server 108 and/or the communication unit 136 of the vehicle 102 to receive data from the vehicle data computing infrastructure 114.

In one embodiment, the data reception module 402 may be configured to communicate with the vehicle dynamic sensors 130 (through the ECU 106) to receive vehicle dynamic data associated with the dynamic operation of the vehicle 102 during the course of the ownership period or the lease term or from a particular point in time until the current point in time. As discussed, the vehicle dynamic sensors 130 may be configured to sense and output vehicle dynamic data that may include but may not be limited to the speed, acceleration, braking, steering, handling, and the like with respect to the operation of the vehicle 102. In particular, the vehicle dynamic data may include one or more values that are associated with the real-time dynamic performance, the location, the operation of the vehicle 102 and/or the wear on the vehicle 102 and one or more components of the vehicle 102 as the vehicle 102 is being operated. In one embodiment, upon receipt of the vehicle dynamic data from the vehicle dynamic sensors 130, the data reception module 402 may be configured to communicate with the ECU 106 to determine a timestamp that may pertain to the particular point in time of receipt of the vehicle dynamic data.

The method 500 may proceed to block 504, wherein the method 500 may include populating the vehicle dynamic data to the dynamic data log 124. In an exemplary embodiment, upon receiving the vehicle dynamic data from the vehicle dynamic sensors 130, the data reception module 402 may be configured to access the dynamic data log 124 stored on the storage unit 120 of the vehicle 102 to store the vehicle dynamic data and the associated timestamp upon a record of the dynamic data log 124.

The method 500 may proceed to block 506, wherein the method 500 may include receiving vehicle safety data from the vehicle safety sensors 132. In one embodiment, the data reception module 402 may be configured to communicate with the vehicle safety sensors 132 (through the ECU 106) to receive vehicle safety data associated with the safe operation of the vehicle 102 during the course of the ownership period or the lease term or from a particular point in time until the current point in time. As discussed, the vehicle safety sensors 132 may be configured to sense and output vehicle safety data that may be associated with the safe operation of the vehicle 102 by one or more drivers of the vehicle 102 during the ownership period or the lease term. In particular, the vehicle safety data may include values associated with the use of the seatbelt by the driver(s) of the vehicle 102, the alertness of the driver(s) of the vehicle 102, and/or the awareness of the driver(s) of the vehicle 102 as the vehicle 102 is being operated by the driver 112. In one embodiment, upon receipt of the vehicle safety data from the vehicle safety sensors 132, the data reception module 402 may be configured to communicate with the ECU 106 to determine a timestamp that may pertain to time of receipt of the vehicle safety data.

The method 500 may proceed to block 508, wherein the method 500 may include populating the vehicle safety data to the safety data log 126. In an exemplary embodiment, upon receiving the vehicle safety data from the vehicle safety sensors 132, the data reception module 402 may be configured to access the safety data log 126 stored on the storage unit 120 of the vehicle 102 to store the vehicle safety data and the associated timestamp upon a record of the safety data log 126.

The method 500 may proceed to block 510, wherein the method 500 may include receiving vehicle maintenance data from the vehicle maintenance sensors 134 and the vehicle data computing infrastructure 114. In one embodiment, the data reception module 402 may be configured to communicate with the vehicle maintenance sensors 134 (through the ECU 106) to receive vehicle maintenance data associated with the maintenance of the vehicle 102 during the course of the lease term or from a particular point in time until the current point in time. As discussed, the vehicle maintenance sensors 134 may be configured to execute sensor logic to analyze data associated with error codes, maintenance issues, maintenance updates, and/or required repairs of one or more electrical, mechanical, and/or structural components of the vehicle 102 and may output maintenance values. The maintenance values may be derived based on an evaluation of maintenance of each respective vehicle component that may be based on if error codes, maintenance issues, maintenance updates, and/or required repairs are remediated and a difference in time between an initial sensing and the remediation of the error codes, maintenance issues, maintenance updates, and/or required repairs with respect to one or more components of the vehicle 102.

The data reception module 402 may additionally be configured to communicate with the vehicle data computing infrastructure 114 to receive vehicle maintenance data that may be associated with a number of insurance claims and purposes for the insurance claims related to the vehicle 102, a number of auto body shop visits and purposes of the auto body shop visits related to the vehicle 102, a number of service shop visits of and purposes of the service body shop visits related to the vehicle 102. In one embodiment, upon receipt of the vehicle maintenance data from the vehicle maintenance sensors 134 and/or the vehicle data computing infrastructure 114, the data reception module 402 may be configured to communicate with the ECU 106 to determine a timestamp that may be associated with a time of receipt of the vehicle maintenance data.

The method 500 may proceed to block 512, wherein the method 500 may include populating the vehicle maintenance data to the maintenance data log 128. In an exemplary embodiment, upon receiving the vehicle maintenance data from the vehicle maintenance sensors 134 and/or the vehicle data computing infrastructure 114, the data reception module 402 may be configured to access the maintenance data log 128 stored on the storage unit 120 of the vehicle 102 to store the vehicle maintenance data and associated timestamp upon a record of the maintenance data log 128.

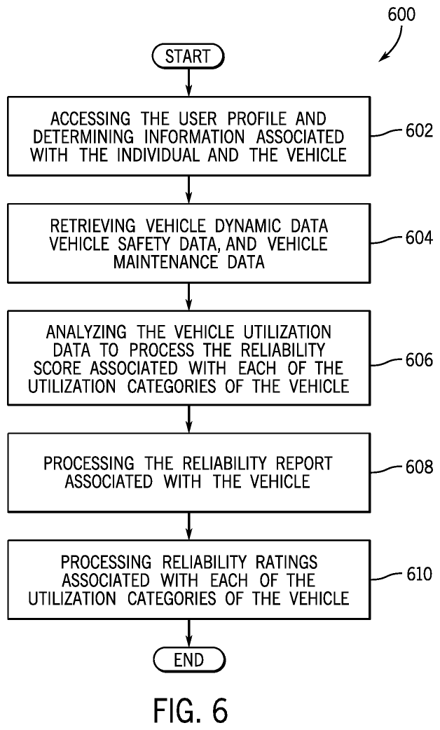

FIG. 6 is a process flow diagram of a method 600 for assigning reliability scores and determining reliability rankings that are associated with the utilization categories of the vehicle 102 and processing the reliability report 200 associated with the vehicle 102 according to an exemplary embodiment of the present disclosure. FIG. 6 will be described with reference to the components of FIG. 1-FIG. 4, though it is to be appreciated that the method 600 of FIG. 6 may be used with additional and/or alternative system components. It is appreciated that the method 600 of FIG. 6 may be executed by vehicle reliability application 110 during one or more periods of time associated with the ownership period or the lease term of the vehicle 102 and/or upon the vehicle 102 being made available within the vehicle resale marketplace.

The method 600 may begin at block 602, wherein the method 600 may include accessing the user profile 122 and retrieving information associated with the individual 112 and the vehicle 102. In an exemplary embodiment, the data reception module 402 of the vehicle reliability application 110 may be configured to access the user profile 122 stored on the storage unit 120 of the vehicle 102 to retrieve information associated with the individual 112 who is owning/leasing the vehicle 102 and the vehicle 102. Upon retrieving the information associated with the individual 112 and the vehicle 102, the data reception module 402 may be configured to communicate data associated with the individual 112 and the vehicle 102 to the reliability scoring processing module 404 and the reliability report processing module 406 of the vehicle reliability application 110.

The method 600 may proceed to block 604, wherein the method 600 may include retrieving vehicle dynamic data, vehicle safety data, and vehicle maintenance data. In an exemplary embodiment, the reliability scoring processing module 404 may be configured to access the dynamic data log 124 stored on the storage unit 120 to retrieve the vehicle dynamic data stored within one or more records of the dynamic data log 124 for one or more periods of time. The reliability scoring processing module 404 may be further configured to access the safety data log 126 stored on the storage unit 120 to retrieve the vehicle safety data stored within one or more records of the dynamic data log 124 for one or more periods of time. Additionally, the reliability scoring processing module 404 may also be configured to access the maintenance data log 128 stored on the storage unit 120 to retrieve the vehicle maintenance data stored within one or more records of the maintenance data log 128 for one or more periods of time.

The method 600 may proceed to block 606, wherein the method 600 may include analyzing the vehicle utilization data to process the reliability scores associated with each of the utilization categories of the vehicle 102. In an exemplary embodiment, the reliability scoring processing module 404 may be configured to analyze the vehicle dynamic data retrieved from the dynamic data log 124 against dynamic thresholds that may be associated with respective categories of dynamic data (e.g., high speed threshold, high acceleration threshold, high braking rate threshold, wear and tear threshold, mileage thresholds, etc.). Accordingly, based on the comparison of one or more values associated with the vehicle dynamic data retrieved from the dynamic data log 124 against the dynamic thresholds, the reliability scoring processing module 404 may classify the driving performance of the vehicle 102 as being poor, fair, good, or excellent. Additionally, based on the comparison of one or more values associated with the vehicle dynamic data retrieved from the dynamic data log 124 against the dynamic thresholds, the reliability scoring processing module 404 may classify the mileage and wear and tear of the vehicle 102 as being poor, fair, good, or excellent.

The reliability scoring processing module 404 may additionally analyze the vehicle dynamic data retrieved from the dynamic data log 124 to determine underlying information associated with the driving performance, the mileage of the vehicle 102, and the wear and tear of the vehicle 102. Such underlying information may pertain to details associated with specific vehicle utilization data that may provide explanation and/or specific details related to certain data points that may be extracted from the vehicle dynamic data with respect to the driving performance utilization category, the mileage utilization category, and the wear and tear utilization category.

The reliability scoring processing module 404 may also be configured to analyze the vehicle safety data retrieved from the safety data log 126 against safety thresholds that may be associated with respective categories of dynamic data (e.g., seatbelt usage threshold, alertness threshold, awareness threshold, etc.) that may classify the driving performance of the vehicle 102 as being poor, fair, good, or excellent. The reliability scoring processing module 404 may additionally analyze the vehicle safety data retrieved from the safety data log 126 to determine underlying information associated with the driving performance. Such underlying information may pertain to details associated with specific vehicle safety data that may provide explanation and/or specific details related to certain data points that may be extracted from the vehicle safety data with respect to the driving performance utilization category of the vehicle 102.

The reliability scoring processing module 404 may also be configured to analyze the vehicle maintenance data retrieved from the maintenance data log 128 against maintenance thresholds that may be associated with respective categories of maintenance data (e.g., maintenance value threshold, insurance claim threshold, body-shop visit threshold, etc.) that may classify the maintenance and repair of the vehicle 102 as being poor, fair, good, or excellent. The reliability scoring processing module 404 may also be configured to analyze the vehicle maintenance data retrieved from the maintenance data log 128 to determine underlying information associated with the maintenance and repair of the vehicle 102. Such underlying information may pertain to details associated with specific vehicle maintenance data that may provide explanation and/or specific details related to certain data points that may be extracted from the vehicle safety data with respect to the maintenance and repair utilization category of the vehicle 102.

In an exemplary embodiment, upon classifying the driving performance, mileage, wear and tear, and the maintenance and repair of the vehicle 102 (during one or more periods of time), the reliability scoring processing module 404 may be configured to assign the reliability scores that are associated with the driving performance, mileage, wear and tear, and the maintenance and repair of the vehicle 102 to the respective utilization categories of the vehicle 102. The reliability scores may be assigned as values that are associated with the poor, fair, good, or excellent classifications for each of the types of vehicle utilization data analyzed by the reliability scoring processing module 404.

The reliability scores may also indicate sub-measurements that may fall within each classification such that the numeric values may specify a range of poor values (e.g., 0.0-3.0) that may indicate how poorly the vehicle 102 has been utilized with respect to each respective utilization category, a range of fair values (e.g., 3.1-5.0) that may indicate how fairly the vehicle 102 has been utilized with respect to each respective utilization category, a range of good values (e.g., 5.1-8.0) that may indicate how the well the vehicle 102 has been utilized with respect to each respective utilization category, and a range of excellent values (e.g., 8.1-10.0) that may indicate how excellently the vehicle 102 has been utilized with respect to each respective utilization category.

Upon assigning the reliability scores respectively to the driving performance utilization category, the mileage category, the wear and tear category, and the maintenance and repair category, the reliability scoring processing module 404 may communicate the reliability scores that are assigned to each of the utilization categories to the reliability report processing module 406 and the reliability rating processing module 308 of the vehicle reliability application 110. The reliability scoring processing module 404 may additionally communicate underlying information that may be associated with the driving performance, mileage, wear and tear, and maintenance and repair of the vehicle 102 to the reliability report processing module 406.

In one embodiment, upon assigning the reliability scores to each of the utilization categories of the vehicle 102, the reliability scoring processing module 404 may be configured to access the vehicle resale reliability log 144 stored on the memory 142 of the external server 108. The reliability scoring processing module 404 may be configured to populate a record associated with the vehicle 102 of the vehicle resale reliability log 144 with the processed reliability scores assigned to each of the utilization categories of the vehicle 102. The reliability scores assigned to each of the utilization categories of the vehicle 102 may be retrieved by the vehicle reliability application 110 as a point of comparison with respect to additional vehicles that may be available for resale within the vehicle resale marketplace to be used to process respective reliability rankings for the additional vehicles.

With continued reference to FIG. 6 upon assigning the reliability scores to the utilization categories of the vehicle 102, the method 600 may proceed to block 608, wherein the method 600 may include processing the reliability report 200 associated with the vehicle 102. In an exemplary embodiment, upon receiving the reliability scores that have been respectively assigned to each of the utilization categories of the vehicle 102 and underlying information that may be associated with each of the utilization categories, the reliability report processing module 406 may be configured to process a reliability report 200 that is associated with the vehicle 102.

In an exemplary embodiment, the reliability report 200 may be processed as an executed data file that may be configured to be executed to present the reliability report 200 in an HMI format. Upon processing the reliability report 200, the reliability report processing module 406 may be configured to store the reliability report 200 associated with the vehicle 102 upon the memory 142 of the external server 108 and/or the storage unit 120 of the vehicle 102. As discussed above, upon retrieving the information associated with the vehicle 102, the data reception module 402 may be configured to communicate data associated with the vehicle 102 to the reliability report processing module 406.

In one embodiment, the reliability report processing module 406 may be configured to populate the reliability report 200 with data associated with the vehicle 102. In particular, the reliability report 200 may be populated with vehicle specifications that are associated with the vehicle 102. As discussed above with respect to FIG. 2A, the reliability report 200 may thereby be presented to include the vehicle description section 202 that provides vehicle specifications of the vehicle 102. In one or more embodiments, the reliability report processing module 406 may additionally populate the reliability report 200 with the reliability scores that are assigned to each respective utilization category of the vehicle 102. Upon populating the reliability scores for each of the respective utilization categories of the vehicle 102, the reliability report processing module 406 may be configured to populate underlying information that may be associated with each of the utilization categories to the reliability report 200. As discussed above with respect to FIGS. 2B-2E, such underlying data may be presented with respect to each particular utilization category of the vehicle 102.

The method 600 may proceed to block 610, wherein the method 600 may include processing reliability rankings associated with each of the utilization categories of the vehicle 102. In an exemplary embodiment, upon receiving the reliability scores assigned to each of the utilization categories from the reliability scoring processing module 404, the reliability rating processing module 408 may be configured to access the vehicle resale reliability log 144 to determine reliability rankings that may be associated with respective utilization categories for one or more subsets of vehicles that are available in the vehicle resale marketplace.

In an exemplary embodiment, the reliability rating processing module 408 may be configured to retrieve the reliability rankings that may be associated with respective utilization categories for one or more subsets of vehicles and may compare them to the reliability scores assigned to the utilization categories of the vehicle 102 to determine reliability rankings in the form of percentile rankings of each of the respective utilization categories of the vehicle 102. In one embodiment, the reliability rating processing module 408 may access the memory 142 of the external server 108 and/or the storage unit 120 of the vehicle 102 to retrieve the stored reliability report 200. Upon retrieving the reliability report 200, the reliability rating processing module 408 may populate the reliability report 200 with the respective reliability rankings as percentile rankings of each of the utilization categories of the vehicle 102. Accordingly, each utilization category may be associated with a reliability ranking that pertains to the ranking of the vehicle 102 in that particular utilization category in comparison to one or more subsets of vehicles that may be available for resale in the vehicle resale marketplace.

In one or more embodiments, upon populating the reliability report 200 with the processed reliability rankings that are associated with the utilization categories of the vehicle 102, the reliability rating processing module 408 may be configured to aggregate the reliability rankings associated with each of the utilization categories into an aggregated reliability percentile ranking that may indicate an overall aggregated reliability value that may be associated with the vehicle 102. In one configuration, the reliability rating processing module 408 may populate the aggregated reliability percentile ranking to the reliability report 200 as an overall reliability ranking measure that may be analyzed by the OEM 104 and/or one or more vehicle dealerships.

In one or more embodiments, the reliability rating processing module 408 may further utilize the communication unit 140 of the external server 108 and/or the communication unit 136 of the vehicle 102 to communicate the reliability report 200 to one or more externally hosted computing systems owned and/or operated by the OEM 104 and/or one or more vehicle dealerships to access the reliability report 200 (e.g., as an HMI). Accordingly, the OEM 104 and/or one or more vehicle dealerships, consumers in the pre-owned vehicle marketplace, and/or third-party entities may determine the reliability of the vehicle 102 in comparison to additional vehicles (one or more subsets of vehicles) that may be available for resale in the vehicle resale marketplace.

In one embodiment, the reliability rating processing module 408 may be configured to process an estimated resale value of the vehicle 102 and/or a residual value of the vehicle 102 that was leased by the individual 112 that may be based on the reliability scores and/or reliability rankings associated with the utilization categories of the vehicle 102. Additional factors may be utilized by the reliability rating processing module 408 to process the estimated resale value and/or the residual value associated with the vehicle 102 may include, but may not be limited to, the brand of the vehicle 102, the model of the vehicle 102, the model year of the vehicle 102, the trim of the vehicle 102, the starting MSRP of the vehicle 102, the current mileage of the vehicle 102, the market value of the vehicle 102, and/or additional market factors associated with the vehicle 102. The reliability rating processing module 408 may utilize the communication unit 140 of the external server 108 and/or the communication unit 136 of the vehicle 102 to communicate the estimated resale value and/or the residual value of the vehicle 102 to one or more externally hosted computing systems owned and/or operated by the OEM 104 and/or one or more vehicle dealerships to allow the OEM 104 and/or one or more vehicle dealerships to analyze the monetary values.

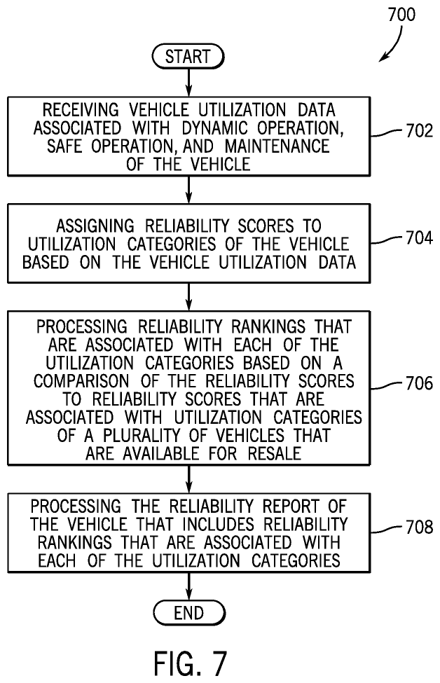

FIG. 7 is a process flow diagram of a method 700 for processing a reliability report 200 associated with a vehicle 102 according to an exemplary embodiment of the present disclosure. FIG. 7 will be described with reference to the components of FIG. 1-FIG. 4, though it is to be appreciated that the method 700 of FIG. 7 may be used with additional and/or alternative system components. The method 700 may begin at block 702, wherein the method 700 may include receiving vehicle utilization data associated with dynamic operation, safe operation, and maintenance of the vehicle 102.

The method 700 may proceed to block 704, wherein the method 700 may include assigning reliability scores to utilization categories of the vehicle based on the vehicle utilization data. In one embodiment, the utilization categories include a driving performance category, a mileage category, a wear and tear category, and a maintenance and repair category. The method 700 may proceed to block 706, wherein the method 700 may include processing reliability rankings that are associated with each of the utilization categories based on a comparison of the reliability scores to reliability scores that are associated with utilization categories of a plurality of vehicles that are available for resale. The method 700 may proceed to block 708, wherein the method 700 may include processing the reliability report 200 of the vehicle 102 that includes reliability rankings that are associated with each of the utilization categories.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for processing a reliability report associated with a vehicle, comprising:
receiving vehicle utilization data associated with dynamic operation, safe operation, and maintenance of the vehicle;
assigning reliability scores to utilization categories of the vehicle based on the vehicle utilization data, wherein the utilization categories include a driving performance category, a mileage category, a wear and tear category, and a maintenance and repair category;
processing reliability rankings that are associated with each of the utilization categories based on a comparison of the reliability scores to reliability scores that are associated with utilization categories of a plurality of vehicles that are available for resale; and
processing the reliability report of the vehicle that includes reliability rankings that are associated with each of the utilization categories.

2. The computer-implemented method of claim 1, wherein receiving the vehicle utilization data includes receiving data pertaining to the dynamic operation of the vehicle from vehicle dynamic sensors of the vehicle, vehicle safety data pertaining the safe operation of the vehicle from safety sensors of the vehicle, and vehicle maintenance data pertaining to the maintenance of the vehicle from vehicle maintenance sensors of the vehicle and a vehicle data computing infrastructure populated with data associated with the vehicle.

3. The computer-implemented method of claim 1, further including storing the vehicle utilization data within data logs that are associated with a dynamic operation, a safe operation, and a maintenance of the vehicle for a particular period of time, wherein the data logs are queried to retrieve and analyze the vehicle utilization data.

4. The computer-implemented method of claim 1, wherein assigning the reliability scores to the utilization categories of the vehicle includes retrieving vehicle dynamic data stored on a dynamic data log, vehicle safety data stored on a safety data log, and vehicle maintenance data stored on a maintenance data log, wherein the vehicle dynamic data, the vehicle safety data, and the vehicle maintenance data are compared against respective threshold values to classify driving performance, mileage, wear and tear, and maintenance and repair of the vehicle.

5. The computer-implemented method of claim 4, wherein the driving performance, the mileage, the wear and tear, and the maintenance and repair of the vehicle are respectively classified as being poor, fair, good, or excellent, wherein the reliability scores are assigned to the utilization categories based on each respective classification associated with the driving performance, the mileage, the wear and tear, and the maintenance and repair of the vehicle.

6. The computer-implemented method of claim 1, wherein processing the reliability rankings includes accessing a vehicle resale reliability log that is configured as a log of the plurality of vehicles that are available for resale within a vehicle resale market, wherein the vehicle resale reliability log includes reliability scores that are assigned to utilization categories of the plurality of vehicles that are available for resale within the vehicle resale market.

7. The computer-implemented method of claim 6, wherein processing the reliability rankings includes retrieving reliability scores that are assigned to utilization categories of at least one subset of the plurality of vehicles that are available for resale within the vehicle resale market and comparing the reliability scores that are assigned to utilization categories of the at least one subset of the plurality of vehicles to the reliability scores that are assigned to the utilization categories of the vehicle.

8. The computer-implemented method of claim 1, wherein processing the reliability report of the vehicle includes processing the reliability report as a data file that is configured to be executed to present the reliability report in a human machine interface format, wherein the reliability rankings are presented as percentile rankings of each of the respective utilization categories of the vehicle.

9. The computer-implemented method of claim 1, further including processing an estimated resale value of the vehicle, wherein the estimated resale value of the vehicle is based on the reliability rankings that are associated with each of the utilization categories.

10. A system for processing a reliability report associated with a vehicle, comprising:
a memory storing instructions when executed by a processor cause the processor to:
receive vehicle utilization data associated with dynamic operation, safe operation, and maintenance of the vehicle;
assign reliability scores to utilization categories of the vehicle based on the vehicle utilization data, wherein the utilization categories include a driving performance category, a mileage category, a wear and tear category, and a maintenance and repair category;
process reliability rankings that are associated with each of the utilization categories based on a comparison of the reliability scores to reliability scores that are associated with utilization categories of a plurality of vehicles that are available for resale; and
process the reliability report of the vehicle that includes reliability rankings that are associated with each of the utilization categories.

11. The system of claim 10, wherein receiving the vehicle utilization data includes receiving data pertaining to the dynamic operation of the vehicle from vehicle dynamic sensors of the vehicle, vehicle safety data pertaining the safe operation of the vehicle from safety sensors of the vehicle, and vehicle maintenance data pertaining to the maintenance of the vehicle from vehicle maintenance sensors of the vehicle and a vehicle data computing infrastructure populated with data associated with the vehicle.

12. The system of claim 10, further including storing the vehicle utilization data within data logs that are associated with a dynamic operation, a safe operation, and a maintenance of the vehicle for a particular period of time, wherein the data logs are queried to retrieve and analyze the vehicle utilization data.

13. The system of claim 10, wherein assigning the reliability scores to the utilization categories of the vehicle includes retrieving vehicle dynamic data stored on a dynamic data log, vehicle safety data stored on a safety data log, and vehicle maintenance data stored on a maintenance data log, wherein the vehicle dynamic data, the vehicle safety data, and the vehicle maintenance data are compared against respective threshold values to classify driving performance, mileage, wear and tear, and maintenance and repair of the vehicle.

14. The system of claim 13, wherein the driving performance, the mileage, the wear and tear, and the maintenance and repair of the vehicle are respectively classified as being poor, fair, good, or excellent, wherein the reliability scores are assigned to the utilization categories based on each respective classification associated with the driving performance, the mileage, the wear and tear, and the maintenance and repair of the vehicle.

15. The system of claim 10, wherein processing the reliability rankings includes accessing a vehicle resale reliability log that is configured as a log of the plurality of vehicles that are available for resale within a vehicle resale market, wherein the vehicle resale reliability log includes reliability scores that are assigned to utilization categories of the plurality of vehicles that are available for resale within the vehicle resale market.

16. The system of claim 15, wherein processing the reliability rankings includes retrieving reliability scores that are assigned to utilization categories of at least one subset of the plurality of vehicles that are available for resale within the vehicle resale market and comparing the reliability scores that are assigned to utilization categories of the at least one subset of the plurality of vehicles to the reliability scores that are assigned to the utilization categories of the vehicle.

17. The system of claim 10, wherein processing the reliability report of the vehicle includes processing the reliability report as a data file that is configured to be executed to present the reliability report in a human machine interface format, wherein the reliability rankings are presented as percentile rankings of each of the respective utilization categories of the vehicle.

18. The system of claim 10, further including processing an estimated resale value of the vehicle, wherein the estimated resale value of the vehicle is based on the reliability rankings that are associated with each of the utilization categories.

19. A non-transitory computer readable storage medium storing instructions that when executed by a computer, which includes a processor perform a method, the method comprising:
receiving vehicle utilization data associated with dynamic operation, safe operation, and maintenance of a vehicle;
assigning reliability scores to utilization categories of the vehicle based on the vehicle utilization data, wherein the utilization categories include a driving performance category, a mileage category, a wear and tear category, and a maintenance and repair category;
processing reliability rankings that are associated with each of the utilization categories based on a comparison of the reliability scores to reliability scores that are associated with utilization categories of a plurality of vehicles that are available for resale; and
processing a reliability report of the vehicle that includes reliability rankings that are associated with each of the utilization categories.

20. The non-transitory computer readable storage medium of claim 19, wherein processing the reliability rankings includes retrieving reliability scores that are assigned to utilization categories of at least one subset of the plurality of vehicles that are available for resale within a vehicle resale market and comparing the reliability scores that are assigned to utilization categories of the at least one subset of the plurality of vehicles to the reliability scores that are assigned to the utilization categories of the vehicle.
